(19) United States
(12) Patent Application Publication
(10) Pub. No.: US 2010/0177116 A1
(43) Pub. Date: Jul. 15, 2010

(54) METHOD AND ARRANGEMENT FOR HANDLING NON-TEXTUAL INFORMATION

(75) Inventors: Lars DAHLLOF, Stockholm (SE); Trevor LYALL, Lidingo (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/351,477

(22) Filed: Jan. 9, 2009

(51) Int. Cl. G09G 5/00; G06K 9/68; H04M 1/00

(52) U.S. Cl. 345/619; 382/218; 455/556.1; 455/466

(57) ABSTRACT

A system for inserting emoticons into text may include capturing a facial expression of a communication device, generating representational data set corresponding to the captured facial expression, comparing the representational data set to a stored data set corresponding to a number of different emoticons, selecting one of the emoticons based on a result the comparison, and inserting the selected emoticon into the text.

### TECHNICAL FIELD

The present invention generally relates to a method, device, and a computer program for controlling input of non-textual symbols in a device and, more particularly, to an arrangement for controlling input of non-textual symbols in a communication device.

### BACKGROUND

Mobile communication devices, for example, cellular telephones, have recently evolved from being simple voice communication devices into the present intelligent communication devices having various processing and communication capabilities. The use of a mobile telephone may involve, for example, such activities as interactive messaging, sending e-mail messages, browsing the World Wide Web (“Web”), and many other activities, both for business purposes personal use. Moreover, the operation of current communication devices is often controlled via user interface means that include, in addition to or instead of conventional keypads, touch-sensitive displays on which a virtual keypad may be displayed. In the latter case, a user typically inputs text and other symbols using an instrument such as a stylus by activating keys associated with the virtual keypad.

Instant messaging and chatting are particularly popular, and one important part aspect of these types of communication is to express emotions using emoticons, e.g., smileys, by inputting keyboard character combinations mapped to recognizable emoticons.

Originally, the smileys were character-based, text representations formed from, for example, a combination of punctuation marks, e.g., “:-)” and “;(”. In later messaging and chatting applications, however, smileys are also provided as unique non-textual symbols, which are small graphical bitmaps, i.e., graphical representations, e.g., icons.

A drawback with current devices, such as mobile phones, PDAs, etc., is such devices typically have to display a menu of what may be a large number of possible non-textual symbols, including the smileys, from which the user may select. For example, the user may need to select from a representational list of smileys or use symbols to form a smiley, which, depending on applications, may be converted to a graphical smiley, e.g., an icon. When chatting, for example, this may be undesirable, as the user must cease to input text, and choose from a list and find a correct smiley. This is time-consuming and may delay and/or disrupt communication.

### SUMMARY

Telephones, computers, PDAs, and other communication devices may include one or more image recording devices, for example, in the form of camera and/or video arrangements. Mobile telephones enabled for video calls, for example, may have a camera directed towards the user, as well, as an image capturing unit directed toward the user's field of view. Embodiments of the present invention may provide the advantage of having a camera on a messaging device, such as a mobile telephone, to generate symbols, for example, non-textual symbols, such as smileys. Thus, the proposed solution uses face detection capability, for example, in connection with facial part analysis and/or other techniques to generate an emoticon without little or no manual input on the part of the user.

Thus, embodiments of the invention according to a first aspect, may relate to a method for inserting non-textual information in a set of information. The method may include the steps of: using a facial image of a user; generating a first data set corresponding to the facial image; comparing the first data set with a stored data set corresponding to the non-textual information; selecting a second data set based on the comparison; and providing the second data set as the non-textual information into the set of information. For example, the set of information may include text-based information. The set of non-textual information may include an emoticon, for example, corresponding to the facial appearance of the user (as captured by an imaging device).

Other embodiments of the invention may relate to a device according to a second aspect, which may include a processing unit; a memory unit; and an image recording arrangement. The image recording arrangement may be configured to capture at least a portion of a user's face. The processing unit may be configured to process the captured image corresponding to at least the portion of the user's face and compare it to a data set stored in the memory. The processing unit may be configured to select a data set based on the comparison. The selected data may be output, for example, to a text processing unit. The device may include a display, input and output (I/O) units, a transceiver portion, and/or an antenna.

Other embodiments of the invention may relate to a computer program stored on a computer readable medium (storage device) including computer-executable instructions for inserting non-textual information in a set of information. The computer program may include: a set of instructions for selecting a facial image of a user; a set of instructions for generating a first data set corresponding to the facial image; a set of instructions for comparing the first data set with a stored data set corresponding to the non-textual information; a set of instructions for selecting a second data set based on the comparison; and a set of instructions for providing the second data set as the non-textual information into the set of information.

### BRIEF DESCRIPTION OF THE DRAWINGS

In the following, the invention is described with reference to drawings illustrating some exemplary embodiments, in which:

FIG. 1 shows a schematically drawn block diagram of an embodiment of a mobile communication device according to the invention;

FIGS. 2a-2c show schematically block diagram of a facial recognition embodiment according to the invention;

FIG. 3 is a flow diagram illustrating exemplary method steps according to the present invention; and

FIG. 4 is a schematically drawn block diagram of an embodiment and screen shots of a communication device during execution of a computer program that implements the method of the present invention.

### DETAILED DESCRIPTION

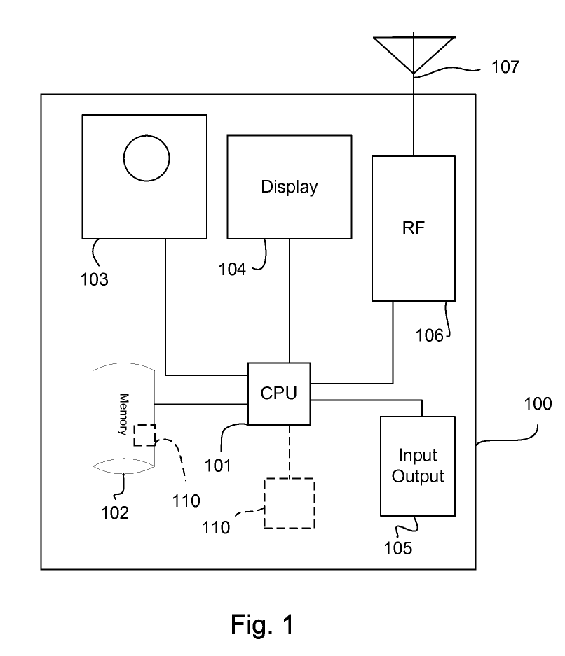

FIG. 1 schematically illustrates a communication device 100 in the form of a mobile telephone device. Communication device 100 may include a processor 101, memory 102, one or more camera units 103, a display 104, input and output (I/O) devices 105, a transceiver portion 106, and/or an antenna 107. Display 104 may be a touch-sensitive display on which a user may input (e.g., write) using, for example, a finger, a stylus or similar instrument, etc. Other I/O mechanisms in the form of a speaker, a microphone, a keyboard may also be provided in communication device 100, functions of which may be well known for a skilled person and thus not described herein in detail. Display 104, I/O devices 105, and/or camera units 103 may communicate with processor 101, for example, via an I/O-interface (not shown). The details regarding how these units communicate are known to the skilled person and are therefore not discussed further. Communication device 100 may, in addition to the illustrated mobile telephone, be a personal digital assistant (PDA) equipped with radio communication means or a computer, stationary or laptop equipped with a camera.

Communication device 100 may be capable of communication via transceiver unit 106 and antenna 107 through an air interface with a mobile (radio) communication system (not shown) such as the well known systems GSM/GPRS, UMTS, CDMA 2000 etc. Other communication protocols are possible.

The present invention may use one of communication device 100's sensor input functions, for example, video telephony, camera units 103, to automatically generate emoticons (smileys) for display and/or transmission, in contrast to conventional input methods using the keyboard or touch screen display to enter the predetermined character combinations.

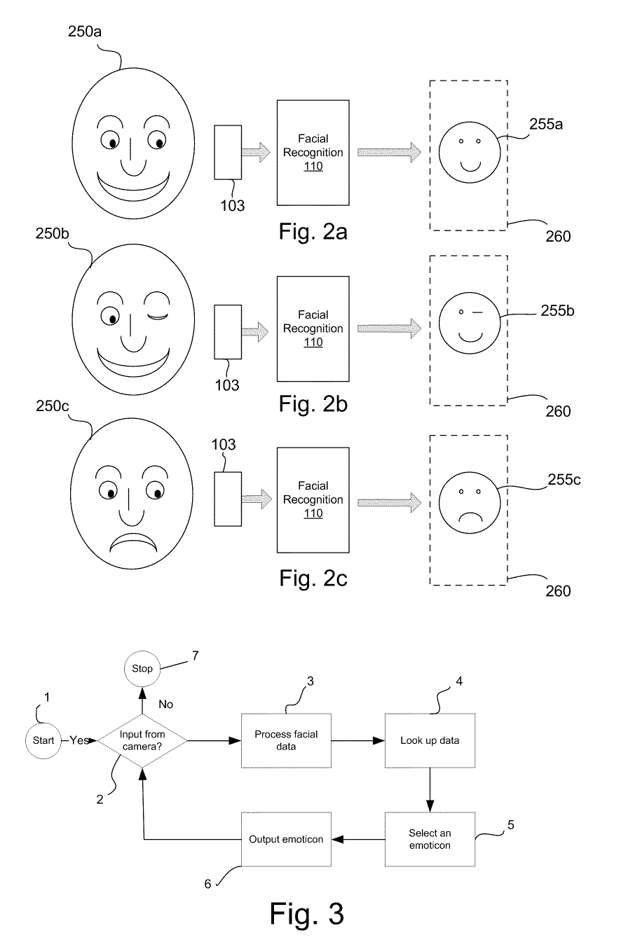

FIGS. 2a-2c and 3, in conjunction with FIG. 1, illustrate the principles of the invention according to one embodiment. When an application, such as chatting or text processing applications, with ability to use smileys, is (1) initiated a user's face 250a-250c (happy, blinking, and unhappy, respectively) may be (2) captured using one or more of camera units 103 of exemplary communication device 100. A facial feature detection application 110, implemented as hardware and/or an instruction set (e.g., program) may be executed by processor 101, which may (3) process the recorded image by camera units 103 and search for certain characteristics, such as leaps (motion), eyes, cheeks etc., and processor 101 (4) may check for the similarities, e.g., in a look-up table and/or an expression database in memory 102. When a smiley and/or emoticon similar to recognized facial data is found and (5) selected, it may be (6) outputted as smileys 255a-255c (smiling/happy, wink and frowning/sad, respectively) into an application 260, which may call the functionality of the present invention. The procedure may be (7) executed until the application is terminated or the user decides to use other input means, for instance.

In addition to still photos, it should be appreciated that the image captured of the user's face may include a number of images, for example, a video capturing movement corresponding to “active” facial expressions, such as eye-rolling, nodding, batting eyelashes, etc. Accordingly, the recognized expressions may be fixed and/or dynamic.

The smileys or emoticons may be in a form of so-called western style, eastern style, East Asian Style, ideographic style, a mixture of styles, or any other usable styles.

One benefit of one or more embodiments is that the user can interact using face representations captured via camera units 103 to express emotions in text form.

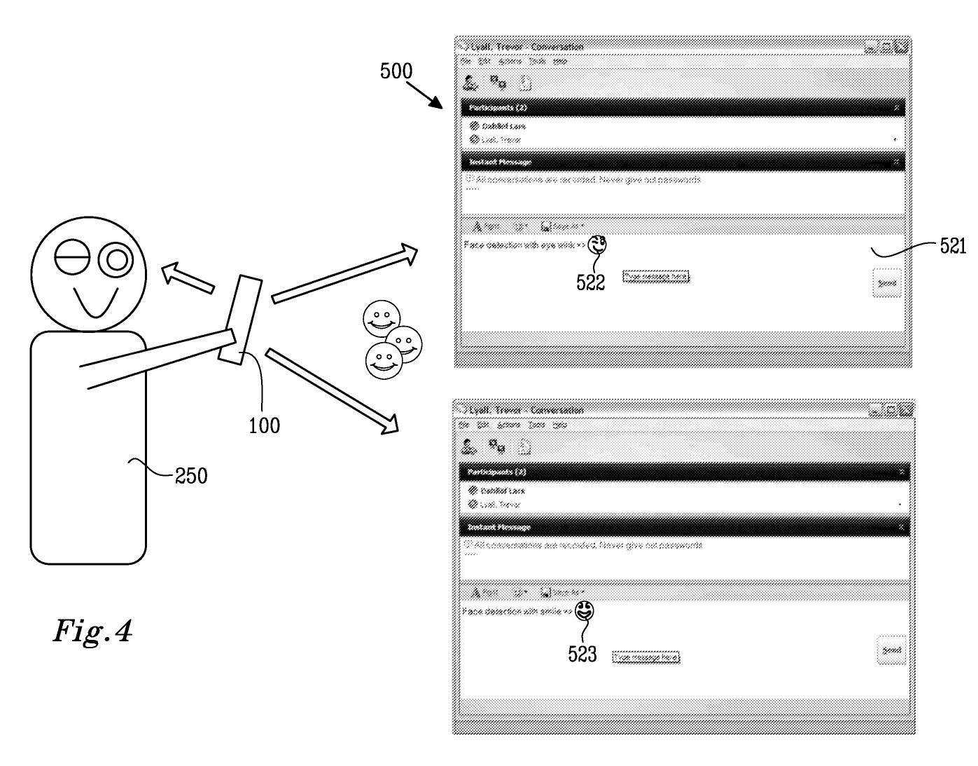

FIG. 4 illustrates an exemplary application embodiment during an instant messaging (“IM”) chat session:
1. A user 250 may compose a text message 520, during which camera unit(s) 103 of communication device 100 may analyze one or more facial features of user 520 to determine when the user intends to express an emotion in text 521.
2. If the user winks with one eye, for example, a wink smiley 522 may be automatically generated and inserted in text 521 at a current position of a text cursor.
3. If the user smiles (to express happiness), for example, a happy smiley 523 may be automatically generated and inserted into text 521 at a current position of a text cursor.

The method according to one embodiment may generally reside in the form of software instructions of a computer program with associated facial feature detection application 110, together with other software components necessary for the operation of communication device 100, in memory 102 of the communication device 100. Facial feature detection application 110 may be resident or it may be loaded into memory 102 from a software provider, e.g., via the air interface and the network, by way of methods known to the skilled person. The program may be executed by processor 101, which may receive and process input data from camera unit(s) 103 and input mechanisms, keyboard or touch sensitive display (virtual keyboard) in communication device 100.

In one embodiment, a user may operate facial feature detection application 110 in a “training phase,” in which the user may associate different facial images to particular emoticons. For example, the user may take a number of photos of various facial expressions and then match individual ones the different expressions to individuals ones of selectable emoticons.

In another embodiment, facial feature detection application 110 may “suggest” an emoticon to correspond to a facial expression identified in a captured image of the user, for example, as a “best approximation.” The user may then be given the option to accept the suggested emoticon or reject it in favor of another emoticon, for example, identified by the user. As a result of one or more iterations of such user “corrections,” facial feature detection application 110 may be “trained” to associate various facial expressions with corresponding emoticons.

In one embodiment, the user may provide a group of images for a particular expression (e.g., a smile), and associate the group of images for that expression to a corresponding emoticon. In this manner, facial feature detection application 110 may develop a “range” or gallery of smiles that would be recognized as (i.e. map to) a single icon, e.g., a smiley face, such that any expression determined to be within the “range” of the expression would be identified as corresponding to that expression.

It should be noted that operations performed by facial feature detection application 110 need not be limited to a particular user. That is, facial feature detection application 110 may identify a facial expression irrespective of the particular user. For example, facial feature detection application 110 may recognize more than one person's smile as being a smile.

It should be noted that the terms “comprising,” “comprises,” “including,” “includes,” and variants thereof, does not exclude the presence of other elements or steps than those listed and the words “a” or “an” preceding an element do not exclude the presence of a plurality of such elements. It should further be noted that any reference signs do not limit the scope of the claims, that the invention may be implemented at least in part by means of both hardware and software, and that several “means”, “units” or “devices” may be represented by the same item of hardware.

The above mentioned and described embodiments are only given as examples and should not be limiting to the present invention. Other solutions, uses, objectives, and functions within the scope of the invention as claimed in the below described patent claims should be apparent for the person skilled in the art.

What is claimed is:

1. A method for inserting non-textual information in text-based information, the method comprising:
providing an image of a face of a user;
generating a first data set corresponding to the image;
comparing the first data set with a stored data set corresponding to the non-textual information;
selecting, based on a result of the comparing, a second data set from the stored data set; and
inserting the second data set, as representative of the non-textual information, into the textual information.

2. The method of claim 1, further comprising:
transmitting the text-based information and the non-textual information as a text message.

3. The method of claim 1, where the non-textual information comprises an emoticon.

4. The method of claim 3, where the emoticon corresponds to a facial expression of the user.

5. The method of claim 3, where the emoticon is in form of western style, eastern style, East Asian Style, ideographic style, a mixture of said styles or any other usable styles.

6. A communication device comprising:
a processing unit;
a memory unit; and
an image recording arrangement to capture an image of at least a portion of a user's face, where the processing unit is to compare the captured image to a data set stored in the memory and select a non-textual data set based on a result of the comparison.

7. The communication device of claim 6, where the selected data is output to a text processing unit.

8. The communication device of claim 6, further comprising a display, a plurality of input and output units, a transceiver portion, and an antenna.

9. The communication device of claim 6, where the communication device comprises at least one of mobile communication device, a personal digital assistant, or a computer.

10. A computer program stored on a computer-readable storage device for inserting non-textual information into a set of text-based information, the computer program comprising:
a set of instructions for determining a facial expression of a user;
a set of instructions for generating data representative of the facial expression;
a set of instructions for comparing the data representative of the facial expression to stored graphic representations corresponding to a number of emoticons;
a set of instructions for selecting one of the stored graphic representations based on a result of the comparison;
a set of instructions for inserting the selected graphic representation into the set of text-based information to form a text message; and
a set of instructions to transmit the text message.
